(19) United States
(12) Patent Application Publication
(10) Pub. No.: US 2011/0269094 A1
(43) Pub. Date: Nov. 3, 2011

(54) Non-compliant orthodontic system

(76) Inventor: David Shearer, Ajax (CA)

(21) Appl. No.: 12/799,732

(22) Filed: Apr. 30, 2010

(51) Int. Cl. A61C 7/36

(52) U.S. Cl. 433/19; 433/24

(57) ABSTRACT

An orthodontic appliance for correction of Class II or Class III malocclusion of maxillary teeth and mandibular teeth of a non-compliant patient. The orthodontic appliance may include an elastic member such as a tension spring for providing a continuous biasing force. A first mounting element is connected to one end of the elastic member for mounting at one of the maxillary teeth or the mandibular teeth. A second mounting element is connected to the other end of the elastic member for mounting at the other of the maxillary teeth or the mandibular teeth. At least one of the first mounting element and the second mounting element includes a fixed functional connector for mounting at the maxillary teeth or the mandibular teeth.

### FIELD

Example embodiments described herein relate generally to orthodontic systems for the non-compliant patient.

### BACKGROUND

A Class II malocclusion, which may be referred to as an “overjet”, or “buck teeth”, occurs when the upper teeth project beyond the lower teeth. A Class III malocclusion, which may be referred to as an “underbite”, occurs when the lower teeth project beyond the upper teeth. In conventional cases, stand-alone elastics or headgear are used to address Class II or Class III malocclusion.

Patient compliance relies at least partly on the patient to correctly follow instructions to benefit from orthodontic treatment. For example, the use of stand-alone elastics or headgear requires specific operation by the patient. However, should the patient fail to correctly follow instructions for the desired treatment, this may result in delay of treatment or potential damage to the teeth.

Other difficulties of existing appliances may be appreciated in view of the following.

### SUMMARY

Some example embodiments provide a non-compliant orthodontic appliance for Class II or Class III malocclusion which provides a continuous pulling force between the maxillary (upper) teeth and the mandibular (lower) teeth.

In an example embodiment, there is provided an orthodontic appliance for correction of Class II or Class III malocclusion of maxillary teeth and mandibular teeth. The orthodontic appliance may include an elastic member in tension for providing a continuous biasing force and having a first end and a second end. A first mounting element is connected to the first end for mounting at one of the maxillary teeth or the mandibular teeth. A second mounting element is connected to the second end for mounting at the other of the maxillary teeth or the mandibular teeth. At least one of said first mounting element and the second mounting element includes a fixed functional connector for mounting at the maxillary teeth or the mandibular teeth.

In another example embodiment, there is provided a method for correction of Class II or Class III malocclusion of maxillary teeth and mandibular teeth. The method includes mounting a first mounting element at one of said maxillary teeth or said mandibular teeth, mounting a second mounting element at the other of said maxillary teeth or said mandibular teeth, at least one of said first mounting element and the second mounting element including a fixed functional connector for mounting at the maxillary teeth or the mandibular teeth, and generating a continuous biasing force in tension between the first mounting element and the second mounting element using an elastic member connected between the first mounting element and the second mounting element.

In yet another example embodiment, there is provided an orthodontic appliance, including: an elastic member in tension for providing a continuous biasing force and having a first end and a second end, an elongate casing for housing the elastic member having one end and an opposing end, an interior of the one end of the casing connected to the second end of the elastic member, the opposing end of the casing defining an aperture for passage of the first end of the elastic member, a first fixed functional connector connected to said first end and positioned exterior of the casing, and a second fixed functional connector connected to an exterior of said one end of the casing.

### BRIEF DESCRIPTION OF THE FIGURES

Embodiments will now be described by way of example with reference to the accompanying drawings, in which like reference numerals are used to indicate similar features, and in which:

FIG. 1 shows a side view of an orthodontic appliance in accordance with an example embodiment;

FIG. 2 shows a sectional side view of the orthodontic appliance of FIG. 1;

FIG. 3 shows a side view of the orthodontic appliance of FIG. 1 in a Class II configuration;

FIG. 4 shows a side view of an orthodontic system for a Class II malocclusion including the Class II configuration of the orthodontic appliance shown in FIG. 3;

FIG. 5 shows a side view of the orthodontic appliance of FIG. 1 in a Class III configuration;

FIG. 6 shows a side view of an orthodontic system for a Class III malocclusion including the Class III configuration of the orthodontic appliance shown in FIG. 5;

FIG. 7 shows a side view of an orthodontic system for a Class III malocclusion including the orthodontic appliance of FIG. 1 in a Class III configuration;

FIG. 8 shows a side view of an orthodontic system for a Class II malocclusion;

FIG. 9 shows a side view of an orthodontic system for a Class III malocclusion;

FIG. 10 shows a side view of an orthodontic appliance in accordance with another example embodiment; and

FIG. 11 illustrates in block diagram form another example orthodontic appliance in accordance with another example embodiment.

### DETAILED DESCRIPTION OF EXAMPLE EMBODIMENTS

Some example embodiments provide a non-compliant orthodontic appliance for Class II or Class III malocclusions which provides a continuous pulling force between the maxillary (upper) teeth and the mandibular (lower) teeth.

In an example embodiment, there is provided an orthodontic appliance for correction of Class II or Class III malocclusion of maxillary teeth and mandibular teeth. The orthodontic appliance may include an elastic member in tension for providing a continuous biasing force and having a first end and a second end. A first mounting element is connected to the first end for mounting at one of the maxillary teeth or the mandibular teeth. A second mounting element is connected to the second end for mounting at the other of the maxillary teeth or the mandibular teeth. At least one of said first mounting element and the second mounting element includes a fixed functional connector for mounting at the maxillary teeth or the mandibular teeth.

In another example embodiment, there is provided a method for using an orthodontic system for Class II or Class III malocclusion of maxillary teeth and mandibular teeth. The method includes mounting a first mounting element of the orthodontic system at one of said maxillary teeth or said mandibular teeth, mounting a second mounting element of the orthodontic system at the other of said maxillary teeth or said mandibular teeth, wherein at least one of said first mounting element and the second mounting element includes a fixed functional connector for mounting at the maxillary teeth or the mandibular teeth, and generating a continuous biasing force in tension between the first mounting element and the second mounting element using an elastic member connected between the first mounting element and the second mounting element.

In yet another example embodiment, there is provided an orthodontic appliance which includes: an elastic member in tension for providing a continuous biasing force and having a first end and a second end, an elongate casing for housing the elastic member having one end and an opposing end, an interior of the one end of the casing connected to the second end of the elastic member, the opposing end of the casing defining an aperture for passage of the first end of the elastic member, a first fixed functional connector connected to said first end and positioned exterior of the casing, and a second fixed functional connector connected to an exterior of said one end of the casing.

As understood in the art, Class II malocclusion (“overjet”) occurs when the maxillary teeth project beyond the mandibular teeth. Class III malocclusion (“underbite”) occurs when the mandibular teeth project beyond the maxillary teeth.

Examples of compliant orthodontic appliances for addressing Class II or Class III malocclusion include stand-alone elastics or headgear, which require patient compliance for normal operation.

Non-compliant orthodontic appliances generally require minimum patient compliance for normal operation. In some conventional non-compliant appliances, a push coil or compression spring is used to address Class II cases. Such appliances rely on an exerted pushing force which is exerted when the patient is biting down. However, such appliances may have difficulties, for example some may only be used for Class II cases only and may not be readily adapted for Class III cases. Another difficulty is that such appliances have limited effectiveness or may break down should the patient open the jaw too widely.

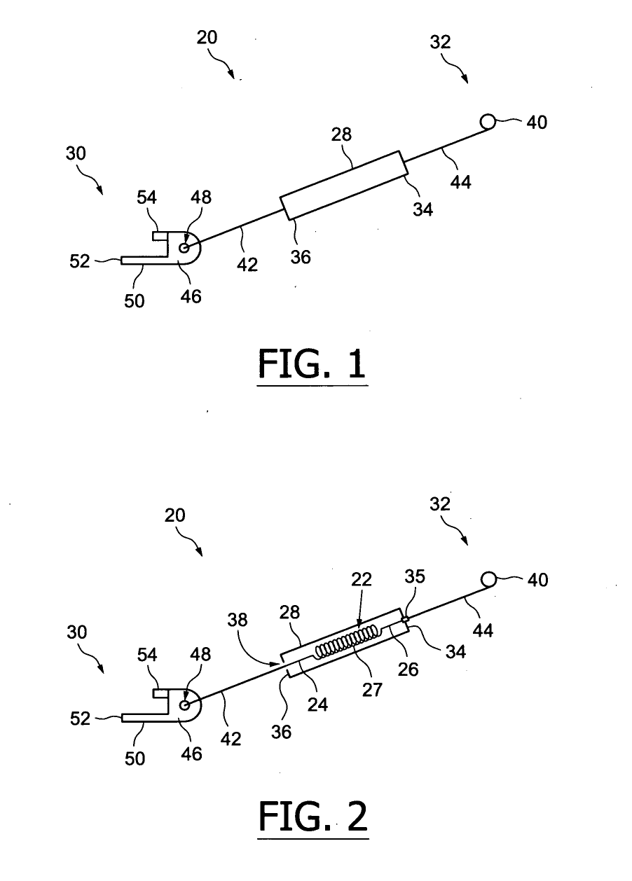

Reference is first made to FIGS. 1 and 2, which show an orthodontic appliance 20 for correction of Class II or Class III malocclusion of maxillary teeth and mandibular teeth of a patient, in accordance with an example embodiment. As minimal patient compliance may be required, the orthodontic appliance 20 may sometimes be referred to as a non-compliant orthodontic appliance.

Generally, the orthodontic appliance 20 provides a continuous pulling force or biasing force between the maxillary (upper) teeth and the mandibular (lower) teeth. The orthodontic appliance 20 includes an elastic member in tension such as a tension spring 22 for providing the continuous biasing force which may be used for correction of Class II or Class III malocclusions. The tension spring 22, as shown, includes a first end 24 and a second end 26 with a coiled member 27 in tension for providing of the biasing force. An elongate casing 28 is cylindrically shaped and hollowed for housing of the tension spring 22. The casing 28 for example shelters the tension spring 22 from food products and protects abrasion by the tension spring 22 against a cheek of the patient. A first mounting element 30 includes a connecting rod 42 which extends from the first end 24 of the tension spring 22 for mounting at one of the maxillary teeth or the mandibular teeth. Similarly, a second mounting element 32 includes a connecting rod 44 extending from the second end 26 of the tension spring 22 for mounting at the other of the maxillary teeth or the mandibular teeth.

The casing 28 includes a first casing end 34 having a fastener 35 such as glue or welding or other mechanisms for connecting an interior of the first casing end 34 to the second end 26 of the tension spring 22. An exterior of the first casing end 34 is also connected to the connecting rod 44 using the fastener 35 (e.g., also by glue or welding or other mechanisms). A second casing end 36 defines an aperture 38 for passage of the first end 24 of the tension spring 24.

The first mounting element 30 and the second mounting element 32 may each include a fixed functional connector requiring minimal or no patient compliance for operation or installation. For example, as shown, the second mounting element 32 includes a loop 40 which may, for example, be a 360 degree closed loop. In other example embodiments, the loop 40 may include an open loop formed of a deformable material which is closeable to a closed loop when installed, and openable for removal thereof or for periodic maintenance. A crimping tool (not shown) may be used by an orthodontist or technician for this purpose. The loop 40 allows the appliance 20 to be attached to braces, for example to a bracket, an arch wire, or other orthodontic appliance. In yet further embodiments, a cylindrical sleeve (not shown) may be originally positioned at connecting rod 44 and slid into place to cover the loop 40 once installed. The cylindrical sleeve may for example be formed of a rigid or rubber material.

The first mounting element 30 may include a body 46 defining an aperture 48 which receives the connecting rod 42. For example, a pin or loop (not shown) may be located at the end of the connecting rod 42 for mounting to the aperture 48. The aperture 48 acts as a pivot which permits rotation of the connecting rod 42. A shaft 50 may be formed of deformable material and extends from the body 46 which may be used to mount the first mounting element 30 to braces of the patient. Once mounted, a distal end 52 of the shaft 50 may be crimped using suitable crimping tools.

The first mounting element 30 may further include a protrusion 54 extending from the body 46 which acts as an anti-rotation stop, and for example provides a limiting obstruction should the patient open the jaw too widely. The protrusion 54 prevents the connecting rod 42 from rotating to beyond a certain degree of rotation. The protrusion 54 may be formed of a rigid material such as stainless steel, or in other embodiments a resilient material such as rubber.

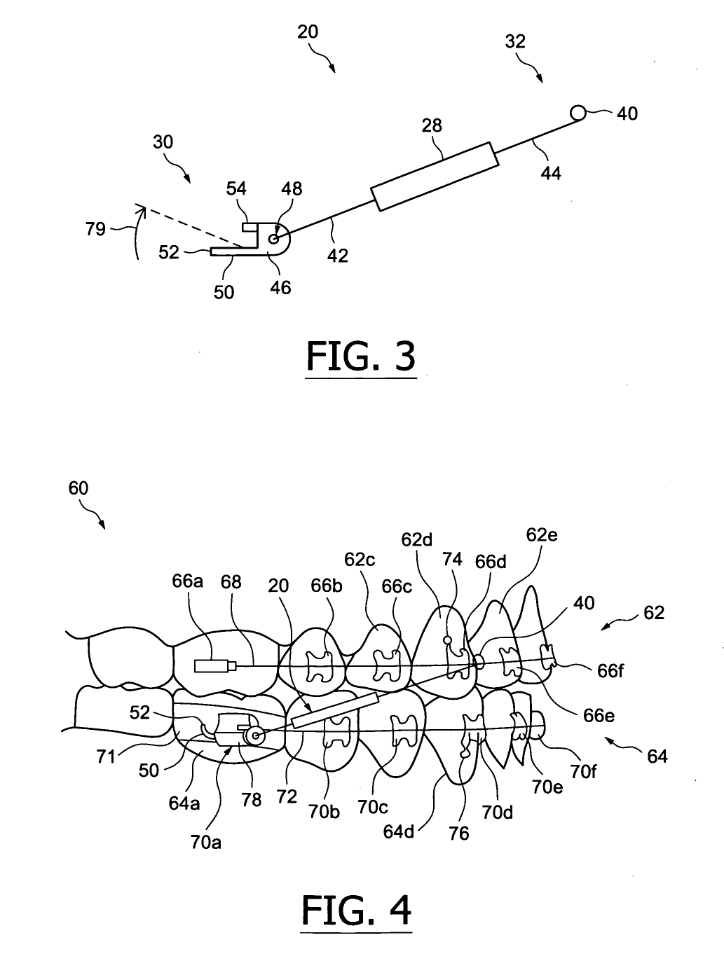

Reference is now made to FIGS. 3 and 4, which show operation of the orthodontic appliance 20 for correction of Class II malocclusion, wherein the maxillary teeth 62 project beyond the mandibular teeth 64. FIG. 4 shows an orthodontic system 60 including the orthodontic appliance 20 mounted exterior to the teeth 62, 64. The orthodontic system 60 includes braces which include, at the maxillary teeth 62, a plurality of maxillary brackets 66a, 66b, . . . 66f (collectively or individually referred to as 66) which are cemented to at least some of the maxillary teeth 62. A maxillary archwire 68 is mounted through each of the brackets 66 and provide a track upon which the teeth 62 may move with continuous pressure. Similarly, at the mandibular teeth 64, the braces include a plurality of mandibular brackets 70a, 70b, 70c, . . . , 70f (collectively or individually referred to as 70), wherein brackets 70b, 70c, . . . , 70f are cemented to at least some of the mandibular teeth 64. As shown, bracket 70a may be mounted to a band 71. As understood in the art, the band 71 includes a member which is mounted to a tooth or molar by circumscribing that tooth or molar. A mandibular archwire 72 is mounted through each of the mandibular brackets 70.

The end mandibular tube or bracket 70a may be mounted to a molar such as the first mandibular molar 64a (as shown), and generally receives an end of the mandibular archwire 72. The end mandibular bracket 70a may also include or define an auxiliary tube 78, which may also be referred to as a “lip bumper tube” for being traditionally used to mount a lip bumper. In example embodiments, the auxiliary tube 78 may be used to receive the shaft 50 of the orthodontic appliance 20.

Still referring to FIG. 4, as shown, the brackets 66d, 70d, mounted to the cuspid (canine) teeth 62d, 64d may also include a hook member 74, 76, respectively, as are readily available in the art. It can be appreciated that some aspects of the orthodontic system 60 may include components from conventional braces or related systems, as is understood in the art.

Attachment and installation of the appliance 20 will now be described in detail, still referring to FIG. 4. The appliance 20 is typically installed by an orthodontist or technician with minimal compliance required from the patient. In order to address the Class II malocclusion, the second mounting element 32 may be attached at a mesial maxillary tooth of the maxillary teeth 62, for example at the maxillary cuspid (canine) tooth 62d (as shown). The first mounting element 30 is for mounting at a distal mandibular tooth of the mandibular teeth 64, for example the first mandibular molar 64a (as shown). In order to mount the appliance 20, the tension spring 22 (FIG. 2) is stretched in tension which permits the mounting elements 30, 32 to reach the desired teeth.

As shown in FIG. 4, the loop 40 is attached to the maxillary arch wire 68, and is positioned between the maxillary cuspid (canine) tooth 62d and the lateral incisor 62e (i.e., between respective brackets 66d, 66e). During installation of the arch wire 68, the arch wire 68 passes through the loop 40 and holds the loop 40 securely in place. The loop 40 is permitted to slide along the arch wire 68 which for example may allow patients an increased range of motion when opening of the jaw. In other example embodiments, the loop 40 is positioned between the maxillary cuspid (canine) tooth 62d and the first bicuspid 62c (i.e., between respective brackets 66d and 66c).

The shaft 50 at the first mounting element 30 is mounted to the auxiliary tube 78 by sliding through the auxiliary tube 78 of the bracket 70a at the first mandibular molar 64a and by crimping the end 52 of the shaft 50 using a crimping tool. The end 52 of the shaft 50 may be crimped upwardly (maxillary) for this Class II configuration, as best shown by motion arrow 79 in FIG. 3, or in other embodiments crimped downwardly (not shown). Once installed, the protrusion 54 engages the end bracket 70a and acts as an anti-rotation stop for preventing the first mounting element 30 from rotating.

In other example embodiments, the auxiliary tube 78 may be mounted to a bracket (not shown) mounted at the second mandibular molar (or other molars).

After installation of the orthodontic appliance 20, the orthodontic appliance 20 may be maintained in place for a period of time, for example a few weeks or even months. After which, the orthodontic appliance 20 can be removed from the end bracket 70a by using pliers onto the shaft 50. The loop 40 can also be removed from the archwire 68. After which, a second like orthodontic appliance can be substituted for the orthodontic appliance 20, wherein the second like orthodontic appliance includes a second tension spring having an increased tension strength when compared to the orthodontic appliance 20. This procedure may be repeated, wherein additional appliances having increasing tensing strength may be periodically substituted, for desired treatment of the patient. In other embodiments, merely the tension spring 22 is replaced in the orthodontic appliance 20. In yet further embodiments, a portion of the orthodontic appliance 20 is substituted, such as the casing 28 and the tension spring 22 together.

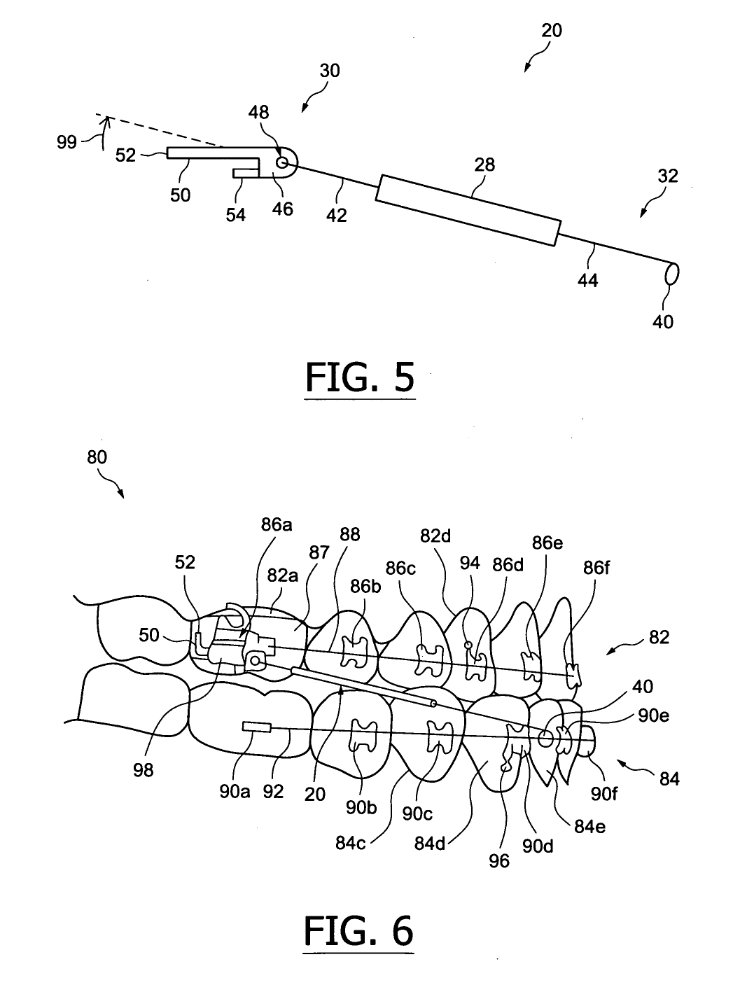

Reference is now made to FIGS. 5 and 6, which show operation of the orthodontic appliance 20 for correction of Class III malocclusion, wherein the mandibular teeth 84 project beyond the maxillary teeth 82. FIG. 6 shows an orthodontic system 80 including the orthodontic appliance 20 mounted exterior to the teeth 82, 84. The orthodontic system 80 includes braces which include, at the maxillary teeth 82, a plurality of maxillary brackets 86a, 86b, 86c, . . . , 86f (collectively or individually referred to as 86), wherein brackets 86b, 86c, . . . , 86f are cemented to at least some of the maxillary teeth 82. As shown, bracket 86a may be mounted to a band 87. A maxillary archwire 88 is mounted to the brackets 86 and provide a track upon which the teeth 82 may move with continuous pressure. Similarly, at the mandibular teeth 84, the braces include a plurality of mandibular brackets 90a, 90b, . . . , 90f (collectively or individually referred to as 90) are cemented to at least some of the mandibular teeth 84. A mandibular archwire 92 is mounted to the mandibular brackets 90.

The end maxillary bracket 86a may be mounted to a molar such as the first maxillary molar 82a (as shown), and generally receives an end of the maxillary archwire 88. The end maxillary bracket 86a may also include or define an auxiliary tube 98 (i.e., “headgear tube”). In example embodiments, the auxiliary tube 98 may be used to receive the shaft 50 of the orthodontic appliance 20.

Still referring to FIG. 6, as shown, the brackets 86d, 90d, mounted to the cuspid (canine) teeth 82d, 84d may also include a hook member 94, 96, respectively, as are readily available in the art.

Attachment and installation of the appliance 20 will now be described in detail, still referring to FIG. 6. In order to address the Class III malocclusion, the second mounting element 32 may be attached at a mesial mandibular tooth of the mandibular teeth 84, for example at the mandibular cuspid (canine) tooth 84d (as shown). The first mounting element 30 is for mounting at a distal maxillary tooth of the maxillary teeth 82, for example the first maxillary molar 82a (as shown).

As shown in FIG. 6, the loop 40 is attached to the mandibular arch wire 92, and is positioned between the mandibular cuspid (canine) tooth 84d and the lateral incisor 84e (i.e., between respective brackets 90d, 90e). During installation, the arch wire 92 passes through the loop 40 and holds the loop 40 securely in place. The loop 40 is permitted to slide along the arch wire 92 which for example may allow patients to have an increased range of motion when opening the jaw. In other example embodiments, the loop 40 is positioned between the mandibular cuspid (canine) tooth 84d and the first bicuspid 84c (i.e., between respective brackets 90d and 90c).

The shaft 50 at the first mounting element 30 is mounted to the auxiliary tube 98 by sliding through the auxiliary tube 98 of the bracket 86a at the first maxillary molar 82a and by crimping or cinching the end 52 of the shaft 50 using a crimping tool. The end 52 of the shaft 50 may be crimped upwardly (maxillary) for this Class III configuration, as best shown by motion arrow 99 in FIG. 5.

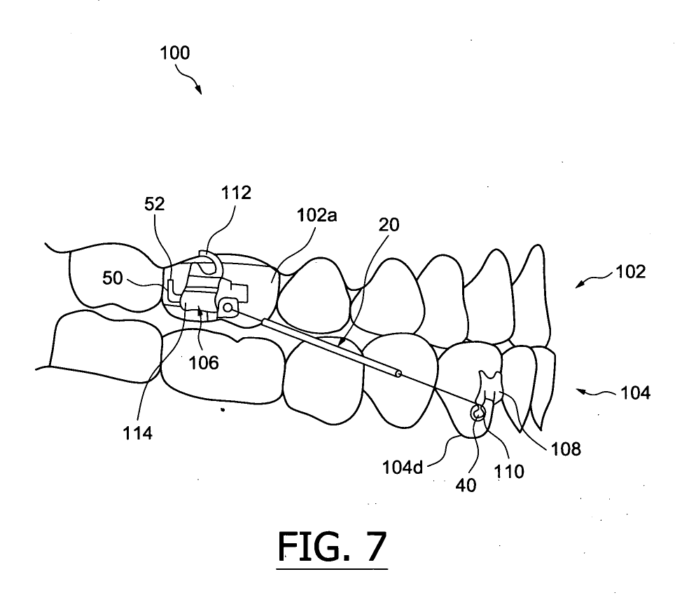

Reference is now made to FIG. 7, which shows an orthodontic system 100 for operation of the orthodontic appliance 20 in accordance with another example embodiment, for correction of Class III malocclusion, wherein the mandibular teeth 104 project beyond the maxillary teeth 102. As shown, this embodiment may not include archwires, and may only require a limited number of bracket mounted to the teeth 102, 104. The orthodontic appliance 20 is mounted exterior to the teeth 102, 104.

The orthodontic system 100 includes a maxillary bracket 106 and a mandibular bracket 108, which are cemented to the first maxillary molar 102a and the mandibular cuspid (canine) tooth 104d, respectively. The maxillary bracket 106 may also include or define an auxiliary tube 114 (i.e., “headgear tube”). The bracket 108 mounted to the cuspid (canine) teeth 104d may also include a hook member 110.

Attachment and installation of the appliance 20 will now be described in detail, still referring to FIG. 7. In order to address the Class III malocclusion, the second mounting element 32 may be attached to the hook 110 at the bracket 108 of the mandibular cuspid (canine) tooth 104d (as shown). The first mounting element 30 is for mounting to the first maxillary molar 102a (as shown).

As shown in FIG. 7, the loop 40 is attached to the hook 110 of the mandibular cuspid (canine) tooth 104d. The shaft 50 is mounted to the auxiliary tube 114 by sliding through the auxiliary tube 114 of the bracket 106 at the first maxillary molar 102a and by crimping the end 52 of the shaft 50 using a crimping tool. The end 52 of the shaft 50 may be crimped upwardly (maxillary) for this Class III configuration.

In another example embodiment, still referring to FIG. 7, the maxillary bracket 106 includes a hook 112. The loop 40 may instead be fastened to the hook 112. In such embodiments, the shaft 50 of the first mounting element 30 may be connected to an auxiliary tube connection (not shown) or other receiving passage defined within the bracket 108, and crimped to maintain the connection.

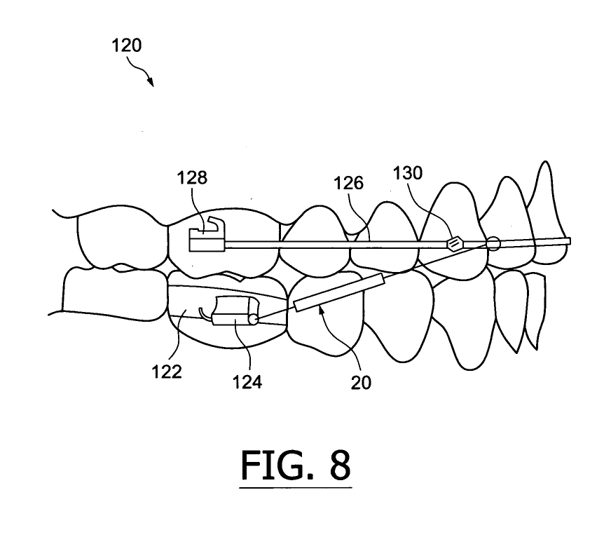

Reference is now made to FIG. 8, which shows an orthodontic system 120 for operation of the orthodontic appliance 20 in accordance with another example embodiment, for correction of Class II malocclusion. In this embodiment, a full set of conventional braces may not be required for operation. As shown, the system 120 includes a band 122 attached to a mandibular molar. As understood in the art, the band 122 includes a member which is mounted to a tooth or molar by circumscribing that tooth or molar. As understood in the art, the band 122 may be connected using a fixed member (not shown) which spans to another band (not shown) connected to a molar on the opposing side of the arch. In example embodiments, the fixed member may for example be a lower lingual arch. Attached to the band 122 is an auxiliary (i.e., headgear) tube 124. At the maxillary teeth, there is a maxillary lip bumper 126 which is attached to the maxillary teeth by a pair of bands (one shown as 128). The lip bumper 126 includes a protrusion 130, bend, or other attachment such as a nut and screw mechanism. The lip bumper 126 may be located at or about the maxillary cuspid (canine) tooth. In operation, one end of the orthodontic appliance 20 is attached or cinched to the auxiliary tube 124, while the other end is looped through the lip bumper 126 and restricted from sliding distally along the lip bumper by the protrusion 130 (or other mechanism).

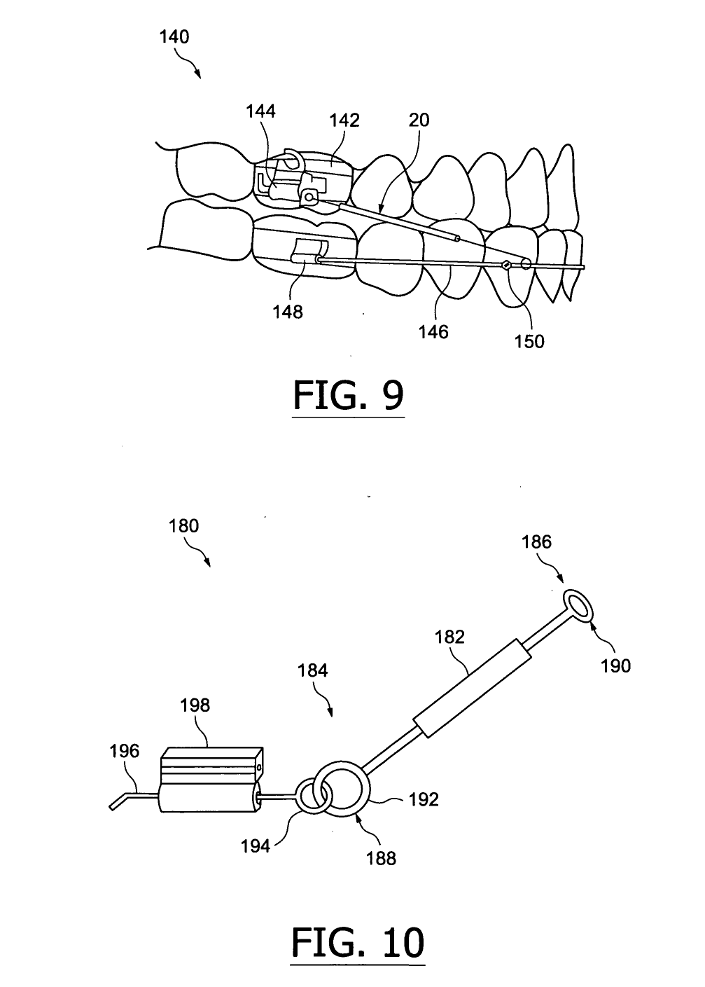

Reference is now made to FIG. 9, which shows an orthodontic system 140 for operation of the orthodontic appliance 20 in accordance with another example embodiment, for correction of Class III malocclusion. As shown, the system 140 includes a band 142 attached to a maxillary molar. The band 142 may be connected to another band (not shown) on a tooth on the opposite side of the arch using for example a rapid palatal expander, a transpalatal arch, or other arch or appliance. Attached to the band 142 is an auxiliary (i.e., headgear) tube 144. At the mandibular teeth, there is a mandibular lip bumper 146 which is attached to the mandibular teeth by a pair of bands (one shown as 148). The lip bumper 146 includes a protrusion 150, bend, or other attachment such as a nut and screw mechanism. In operation, one end of the orthodontic appliance 20 is attached or cinched to the auxiliary tube 144, while the other end is looped through the lip bumper 146 and restricted from sliding distally along the lip bumper by protrusion 150 (or other mechanism).

It can be appreciated that, in some instances, the above-described orthodontic appliance 20 may provide a similar (if not better) continuous exerted force than in the case of conventional stand-alone elastics, as there is minimum cooperation or compliance required by the patient. In some example embodiments, the orthodontic appliance 20 may not be removable by the patient in the regular course of use.

It can further be appreciated that, the same orthodontic appliance 20 may be used for both Class II and Class III cases, and for both left and right sides of the teeth. Each orientation may be installed without modification or disassembly of the orthodontic appliance 20. For example, in some conventional non-compliant appliances having compression springs for Class II cases, installation of such appliances in Class III cases may result in the patient biting down onto the appliance which is generally not desirable and may not result in the intended treatment.

Although only half (i.e., the right side) of the teeth are illustrated in the Figures for illustration purposes, it is understood that the orthodontic appliance 20 may be used on the left side in a similar fashion. In other words, two of the orthodontic appliances may be used in combination for Class II or Class III malocclusion, one on each of the left and right sides of the teeth. In other embodiments, only one orthodontic appliance 20 is used on either the left side or the right side.

Suitable materials for the orthodontic appliance 20 include medical grade materials or other materials which may provide sufficient rigidity with some flexibility or deformability, depending on the particular application. Suitable materials may be readily cleansed for long-term maintenance and to prevent bacterial growth. Example materials include stainless steel, and suitable plastics. The tension spring 22 may for example be formed of suitable alloys such as nickel-titanium alloy or copper-nickel-titanium alloy.

In some example embodiments, further examples of fixed functional connectors which may be used for the first mounting element 30 or second mounting element 32 include cement bonding, and other suitable connectors.

Reference is now made to FIG. 10, which shows another orthodontic appliance 180 illustrating another example fixed functional connector, in accordance with another example embodiment. The orthodontic appliance 180 may include a casing 182 including therein elastic member in tension (not shown) for providing a continuous biasing force in tension and having a first end 184 and a second end 186. A first mounting element 188 is connected to the first end 184 for mounting at one of the maxillary teeth or the mandibular teeth. A second mounting element 190 is connected to the second end 186 for mounting at the other of the maxillary teeth or the mandibular teeth. The first mounting element 188 may include a loop 192 which is attached to a second loop 194 at the end of a connecting rod 196. The connecting rod 196 may be cinched (either up or down) to an auxiliary (i.e., headgear) tube 198, in a similar manner as discussed above.

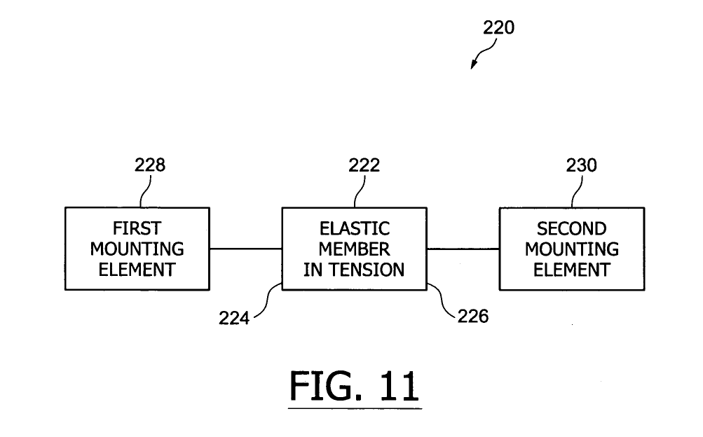

Reference is now made to FIG. 11, which illustrates in block diagram form another orthodontic appliance 220 in accordance with another example embodiment, for correction of Class II or Class III malocclusion of maxillary teeth and mandibular teeth. The orthodontic appliance 220 may include an elastic member in tension 222 for providing a continuous biasing force and having a first end 224 and a second end 226. A first mounting element 228 is connected to the first end 224 for mounting at one of the maxillary teeth or the mandibular teeth. A second mounting element 230 is connected to the second end 226 for mounting at the other of the maxillary teeth or the mandibular teeth. At least one of said first mounting element 228 and the second mounting element 230 may include a fixed functional connector for mounting at the maxillary teeth or the mandibular teeth.

For Class II malocclusion, the first mounting element 228 is for mounting at a mesial maxillary tooth of the maxillary teeth and the second mounting element 230 is for mounting at a distal mandibular tooth of the mandibular teeth. For Class III malocclusion, the first mounting element 228 is for mounting at a mesial mandibular tooth of the mandibular teeth and the second mounting element 230 is for mounting at a distal maxillary tooth of the maxillary teeth

In some example embodiments, a kit of parts may be provided for treatment of a patient having Class II or Class III malocclusion using an orthodontic system. The kit of parts may include any combination or sub-combination of the aforementioned orthodontic systems, orthodontic appliances, braces, and associated operating or installation instructions to be followed by a technician or an orthodontist. The kit of parts may also include a plurality of elastic members or tension spring members of increasing tension strength.

It can be appreciated that, although various embodiments may include non-compliant orthodontic appliances, this does not preclude the use of such appliances in combination with traditional compliant orthodontic appliances, such as headgear or elastics.

Variations may be made to some example embodiments, which may include combinations and sub-combinations of any of the above. The various embodiments presented above are merely examples and are in no way meant to limit the scope of this disclosure. Variations of the innovations described herein will be apparent to persons of ordinary skill in the art, such variations being within the intended scope of the present disclosure. In particular, features from one or more of the above-described embodiments may be selected to create alternative embodiments comprised of a sub-combination of features which may not be explicitly described above. In addition, features from one or more of the above-described embodiments may be selected and combined to create alternative embodiments comprised of a combination of features which may not be explicitly described above. Features suitable for such combinations and sub-combinations would be readily apparent to persons skilled in the art upon review of the present disclosure as a whole. The subject matter described herein intends to cover and embrace all suitable changes in technology.

What is claimed is:

1. An orthodontic system for Class II or Class III malocclusion of maxillary teeth and mandibular teeth, comprising:
an elastic member in tension for providing a continuous biasing force and having a first end and a second end;
a first mounting element connected to said first end for mounting at one of said maxillary teeth or said mandibular teeth; and
a second mounting element connected to said second end for mounting at the other of said maxillary teeth or said mandibular teeth, wherein at least one of said first mounting element and said second mounting element include a fixed functional connector for mounting at said maxillary teeth or said mandibular teeth.

2. The orthodontic system as claimed in claim 1, wherein for Class II malocclusion the first mounting element is for mounting at a mesial maxillary tooth of the maxillary teeth and the second mounting element is for mounting at a distal mandibular tooth of the mandibular teeth; and wherein for Class III malocclusion the first mounting element is for mounting at a mesial mandibular tooth of the mandibular teeth and the second mounting element is for mounting at a distal maxillary tooth of the maxillary teeth.

3. The orthodontic system as claimed in claim 1, wherein said elastic member includes a tension spring.

4. The orthodontic system as claimed in claim 1, further comprising an elongate casing for housing the elastic member and having one end and an opposing end, an interior of said one end of the casing connected to the second end of the elastic member, and an exterior of said one end of the casing connected to the second mounting element, said one end of the casing thereby facilitating connection between said second end of the elastic member and the second mounting element.

5. The orthodontic system as claimed in claim 4, wherein the opposing end of the casing defines an aperture for passage of the first end of the elastic member.

6. The orthodontic system as claimed in claim 1, wherein the first mounting element or the second mounting element includes an open or closed loop.

7. The orthodontic system as claimed in claim 6, wherein the loop is for mounting to an arch wire.

8. The orthodontic system as claimed in claim 1, wherein the first mounting element or the second mounting element includes a shaft.

9. The orthodontic system as claimed in claim 8, wherein the shaft is for mounting to an auxiliary tube.

10. The orthodontic system as claimed in claim 1, wherein the first mounting element or the second mounting element includes a protrusion for preventing rotational of the elastic member beyond a certain degree.

11. The orthodontic system as claimed in claim 1, wherein the first mounting element or the second mounting element is for mounting to one or more orthodontic appliances attached to said maxillary teeth and said mandibular teeth.

12. A method for correction of Class II or Class III malocclusion of maxillary teeth and mandibular teeth, the method comprising:
mounting a first mounting element at one of said maxillary teeth or said mandibular teeth;
mounting a second mounting element at the other of said maxillary teeth or said mandibular teeth, at least one of said first mounting element and the second mounting element including a fixed functional connector for mounting at the maxillary teeth or the mandibular teeth; and
generating a continuous biasing force in tension between the first mounting element and the second mounting element using an elastic member connected between the first mounting element and the second mounting element.

13. The method as claimed in claim 12, further comprising:
maintaining the first mounting element and the second mounting element onto the maxillary teeth and mandibular teeth for a period of time; and
substituting said elastic member with a second elastic member having an increased tension strength.

14. The method as claimed in claim 12, wherein for Class II malocclusion the first mounting element is mounted at a mesial maxillary tooth of the maxillary teeth and the second mounting element is mounted at a distal mandibular tooth of the mandibular teeth; and wherein for Class III malocclusion the first mounting element is mounted at a mesial mandibular tooth of the mandibular teeth and the second mounting element is mounted at a distal maxillary tooth of the maxillary teeth.

15. The method as claimed in claim 12, wherein said elastic member includes a tension spring.

16. The method as claimed in claim 12, wherein the first mounting element or the second mounting element includes an open or closed loop.

17. The method as claimed in claim 12, wherein the first mounting element or the second mounting element includes a shaft.

18. An orthodontic appliance, comprising:
an elastic member in tension for providing a continuous biasing force and having a first end and a second end;
an elongate casing for housing the elastic member having one end and an opposing end, an interior of the one end of the casing connected to the second end of the elastic member, the opposing end of the casing defining an aperture for passage of the first end of the elastic member;
a first fixed functional connector connected to said first end and positioned exterior of the casing; and
a second fixed functional connector connected to an exterior of said one end of the casing.
